(19) United States
(12) Patent Application Publication
(10) Pub. No.: US 2018/0096356 A1
(43) Pub. Date: Apr. 5, 2018

(54) METHOD AND APPARATUS FOR INITIATING A VERIFIED PAYMENT TRANSACTION

(71) Applicant: MASTERCARD INTERNATIONAL INCORPORATED, Purchase, NY (US)

(72) Inventor: Pravin Parekh, Pune (IN)

(21) Appl. No.: 15/717,299

(22) Filed: Sep. 27, 2017

(30) Foreign Application Priority Data
Oct. 3, 2016 (SG) 10201608271Q

(51) Int. Cl. G06Q 20/40; G06Q 20/32

(52) U.S. Cl. CPC G06Q 20/40145; G06Q 20/3278

(57) ABSTRACT

The present disclosure generally relates to a method and apparatus for initiating a verified payment transaction between the customer and a merchant. The method comprises: receiving image data associated with facial features of the customer; initiating a verification process comprising: generating first facial metrics based on the image data; comparing the first facial metrics to predetermined facial metrics of the customer; and verifying the customer's identity based on the comparison of the first facial metrics to the predetermined facial metrics; and providing authorization for details of a customer payment vehicle to be communicated to a merchant payment terminal in response to positive verification of the customer's identity from the verification process, wherein the payment transaction is initiated upon communication of the details of the customer payment vehicle to the merchant payment terminal.

### TECHNICAL FIELD

The present disclosure generally relates to a method and apparatus for initiating a verified payment transaction. More particularly, the present disclosure describes various embodiments of a computerized method and an apparatus for initiating a verified payment transaction performed at a merchant's location for the merchant to receive funds from an identity-verified customer.

### BACKGROUND

Transactions between customers and merchants, e.g. for purchasing of products, goods, and/or services, have conventionally been paid with cash. Cashless payment vehicles such as credit and debit cards are increasingly popular with customers and merchants, provided that the merchants have the necessary systems and devices installed at their merchant locations, i.e. physical stores and shops. Moreover, the use of credit cards may be preferred due to the benefits provided by the issuing banks to the customers or card holders, such benefits including cash rebates, discounts, and frequent flyer miles.

A typical payment transaction at a merchant store requires the customer to pass his/her credit card to the staff or cashier, who then swipes or inserts the credit card into a reader. Alternatively, for lower value transactions, customers may rely on contactless payment modes, such as MasterCard PayPass™ or Visa payWave™, to pay for transactions with the merchant simply by waving a credit card over or in front of a reader at the merchant point of sale (POS) terminal. This contactless payment mode relies on wireless communication protocols such as radio-frequency identification (RFID) or near field communication (NFC).

Customers often hold multiple credit cards to maximize the benefits according to their spending patterns, due to the diversity of benefits from different issuing banks. This possibly results in customers carrying all of their credit cards in their wallets, mainly because it is difficult to foresee which credit card will give them optimum benefits when they shop at merchant stores. As a result, their wallets tend to be relatively thick due to the stacking of the credit cards therein, and are thus more cumbersome to carry around.

Emerging payment technologies have provided a more convenient means to make payment transactions at physical merchant stores with credit cards, but without actually carrying the physical credit cards. For example, NFC-enabled smartphone devices or mobile phones can emulate credit cards or store data to function as virtual credit cards. A customer would need to associate a credit card or other payment vehicle with his/her mobile phone. In order to make a payment to the merchant, the customer holds the mobile phone over an NFC-enabled POS terminal of the merchant, similar to the contactless payment modes of physical credit cards.

However, one problem associated with emulating credit cards on mobile phones is that the credit cards associated with the mobile phones are at risk of being misused. Particularly, if the mobile phone is lost, the credit cards may be compromised and can be fraudulently used by others. There is also a risk of theft of sensitive credit card data from the mobile phones which can happen if someone places a portable NFC-reader near the mobile phone of a customer.

Therefore, in order to address or alleviate at least one of the aforementioned problems and/or disadvantages, there is a need to provide a method and apparatus for initiating a verified payment transaction, in which there is at least one improved feature over the prior art.

### SUMMARY

According to a first aspect of the present disclosure, there is provided a computerized method for initiating a verified payment transaction between the customer and a merchant. The method comprises: receiving image data associated with facial features of the customer; initiating a verification process comprising: generating first facial metrics based on the image data; comparing the first facial metrics to predetermined facial metrics of the customer; and verifying the customer's identity based on the comparison of the first facial metrics to the predetermined facial metrics; and providing authorization for details of a customer payment vehicle to be communicated to a merchant payment terminal in response to positive verification of the customer's identity from the verification process, wherein the payment transaction is initiated upon communication of the details of the customer payment vehicle to the merchant payment terminal.

According to a second aspect of the present disclosure, there is a non-transitory computer-readable medium storing computer-readable instructions that, when executed, cause a processor to perform steps of a method for initiating a verified payment transaction between the customer and a merchant. The method comprises: receiving image data associated with facial features of the customer; initiating a verification process comprising: generating first facial metrics based on the image data; comparing the first facial metrics to predetermined facial metrics of the customer; and verifying the customer's identity based on the comparison of the first facial metrics to the predetermined facial metrics; and providing authorization for details of a customer payment vehicle to be communicated to a merchant payment terminal in response to positive verification of the customer's identity from the verification process, wherein the payment transaction is initiated upon communication of the details of the customer payment vehicle to the merchant payment terminal.

According to a third aspect of the present disclosure, there is an apparatus for initiating a verified payment transaction between the customer and a merchant. The apparatus comprises: a processor; and a memory configured to store computer-readable instructions that, when executed, cause the processor to perform steps of a method. The method comprises: receiving image data associated with facial features of the customer; initiating a verification process comprising: generating first facial metrics based on the image data; comparing the first facial metrics to a predetermined facial metrics of the customer; and verifying the customer's identity based on the comparison of the first facial metrics to the predetermined facial metrics; and providing authorization for details of a customer payment vehicle to be communicated to a merchant payment terminal in response to positive verification of the customer's identity from the verification process, wherein the payment transaction is initiated upon communication of the details of the customer payment vehicle to the merchant payment terminal.

An advantage of the method/apparatus for initiating a verified payment transaction of the present disclosure is that the customer's identity is verified before communication of sensitive payment card information to the merchant. The verification is performed based on the customer's facial features, e.g. anthropometric measurements and/or retinal information. The use of facial features provides a more reliable verification of the customer's identity as compared to conventional PIN or passwords, which could be stolen or hacked with brute-force algorithms. The customer will have greater assurance in that his/her payment card information will only be communicated to the merchant when there is positive verification based on the image data of his/her facial features to verify his/her identity.

A method and apparatus for initiating a verified payment transaction according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is a flowchart illustration of a method for initiating a verified payment transaction, in accordance with an embodiment of the present disclosure.

FIG. 2 is an illustration of a computerized network of electronic devices for performing the method of FIG. 1.

FIG. 3A is an illustration of a communication network between a mobile device and a merchant payment terminal, in accordance with an embodiment of the present disclosure.

FIG. 3B is an illustration of a communication network between a mobile device and a merchant payment terminal, in accordance with another embodiment of the present disclosure.

FIG. 4 is an illustration of a block diagram of the technical architecture of a mobile device, in accordance with an embodiment of the present disclosure.

FIG. 5 is an illustration of a block diagram of the technical architecture of a remote server, in accordance with an embodiment of the present disclosure.

### DETAILED DESCRIPTION

In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated. As used herein, the term “set” corresponds to or is defined as a non-empty finite organization of elements that mathematically exhibits a cardinality of at least one (i.e., a set as defined herein can correspond to a unit, singlet, or single element set, or a multiple element set), in accordance with known mathematical definitions. The recitation of a particular numerical value or value range herein is understood to include or be a recitation of an approximate numerical value or value range.

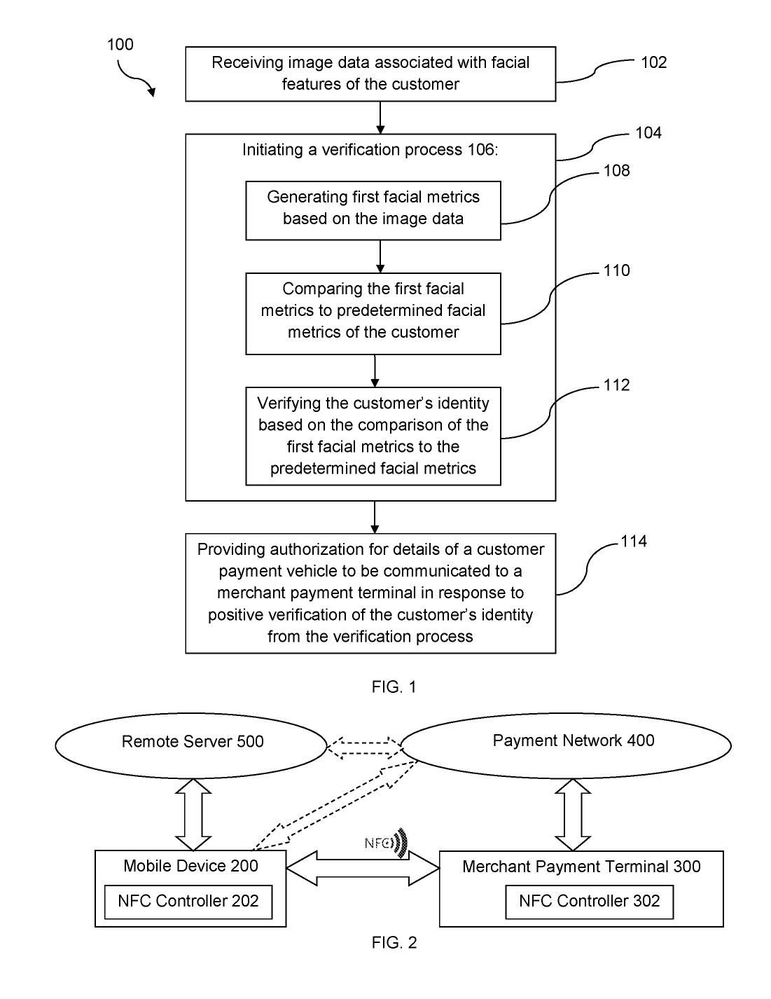

For purposes of brevity and clarity, descriptions of embodiments of the present disclosure are directed to a method and apparatus for initiating a verified payment transaction, in accordance with the drawings in FIG. 1 to FIG. 5. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In representative or exemplary embodiments of the present disclosure, a method 100 for initiating a verified payment transaction is described hereinafter, as illustrated in FIG. 1. Particularly, the method 100 is a computerized method 100 performed by a software application executable on an apparatus such as an electronic device, e.g. a mobile device 200 (as shown in FIG. 2), belonging to a customer prior to initiating a verified payment transaction with a merchant. The electronic/mobile device 200 may include mobile phones, smartphones, personal digital assistants (PDAs), key fobs, transponder devices, NFC-enabled devices, tablets, and/or computers.

Referring to FIG. 2, the mobile device 200 is configured to communicate with a merchant payment terminal 300, e.g. a merchant billing machine/device, located at a merchant store or shop to initiate a payment transaction. Particularly, the customer may hold or position the mobile device 200 over the merchant payment terminal 300 and data can be communicated therebetween. The data includes customer payment vehicle details communicated from the mobile device 200 to the merchant payment terminal 300 for subsequent processing of the payment transaction. As used in this document, the term “payment vehicle” refers to any suitable cashless payment mechanism, such as a credit card, a debit card, a prepaid card, a charge card, a membership card, a promotional card, a frequent flyer card, an identification card, a gift card, and/or any other payment cards that may hold payment card information (e.g. details of customer account or payment card) and which may be stored electronically on a mobile device.

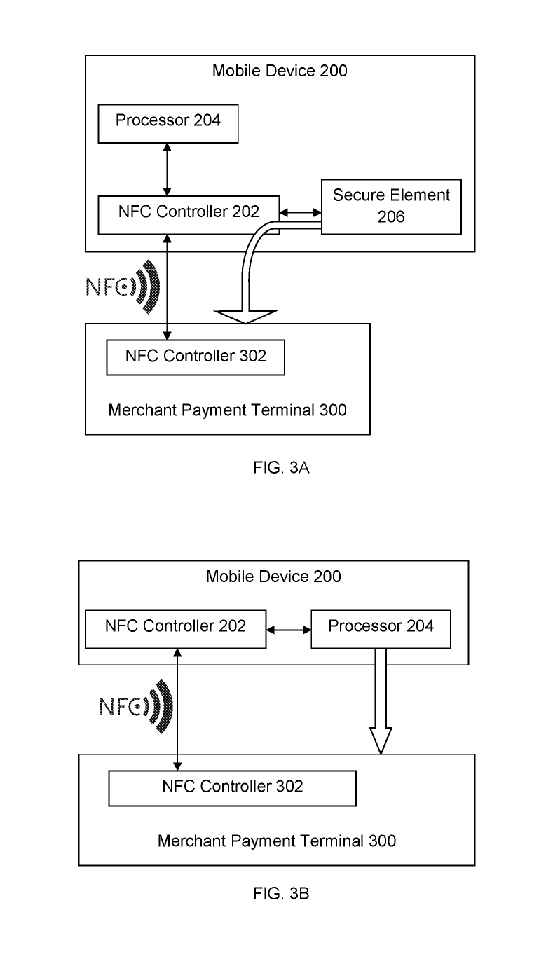

The data communication between the mobile device 200 and the merchant payment terminal 300 occurs via a wireless communication protocol, such as RFID or NFC. In embodiments of the present disclosure, the mobile device 200 is NFC-enabled and comprises an NFC controller/chip/component 202 (as shown in FIGS. 3A and 3B), and the merchant payment terminal 300 is likewise NFC-enabled and comprises an NFC controller/chip/component 302 (as shown in FIGS. 3A and 3B). Further, the merchant payment terminal 300 is communicatively linked to a payment network 400 (which links financial institutions) to perform the subsequent processing of the payment transaction, and the mobile device 200 may be communicatively linked to a remote server or cloud 500 to facilitate operation of the method 100.

The customer payment vehicle or payment card information is communicated from the mobile device 200 to the merchant payment terminal 300 for subsequent processing of the payment transaction. As described above, the NFC-enabled mobile device 200 can emulate credit cards/payment cards and function as a virtual payment card. This emulation can be configured by hardware and/or software elements of the mobile device 200. The credit card or payment card information is first assigned to or associated with the mobile device 200, e.g. by inputting the information on a software application executed on the mobile device 200. The payment card information may also be input into the mobile device 200 by capturing a photo of the physical payment card. Once the payment card information is stored on the mobile device 200, this information can be communicated to the merchant payment terminal 300 via the NFC protocol. Alternatively, payment card information may be stored on the remote server or cloud 500 for retrieval by the mobile device 200.

In some embodiments of the present disclosure as shown in FIG. 3A, the mobile device 200 comprises the NFC controller 202 and a processor 204 communicatively linked to each other. The mobile device 200 further comprises an embedded secure element 206, e.g. a SIM card. The payment card information may be assigned to or stored on the embedded secure element 206, and may be retrieved by a software application executed on the mobile device 200 as required. When the customer holds the mobile device 200 close to the merchant payment terminal 300, the NFC controllers 202 and 302 become communicatively linked to each other, enabling data communication to occur between the embedded secure element 206 and the merchant payment terminal 300. Particularly, the payment card information can be transmitted from the embedded secure element 206 to the merchant payment terminal 300 for subsequent processing of the payment transaction by the merchant.

In some other embodiments of the present disclosure as shown in FIG. 3B, the mobile device 200 comprises the NFC controller 202 and the processor 204 communicatively linked to each other. A software application executable on the operating system of the mobile device 200 allows users to emulate functions of the absent embedded secure element 206. This emulation, or host card emulation (HCE) specifically, allows the payment card information to be stored on memory or storage of the mobile device 200. Alternatively, the payment card information may be stored on the remote server/cloud 500, which is accessible by the mobile device 200 using the software application. When the customer holds the mobile device 200 close to the merchant payment terminal 300, the NFC controllers 202 and 302 become communicatively linked to each other, enabling data communication to occur between the software application and the merchant payment terminal 300. Particularly, the payment card information can be transmitted from the software application executed on the mobile device 200 to the merchant payment terminal 300 for subsequent processing of the payment transaction by the merchant. The payment card information may be directly retrieved from memory or storage of the mobile device 200, or alternatively retrieved from the remote server/cloud 500 by the software application.

In various embodiments of the present disclosure, the payment card information is communicable from the mobile device 200 to the merchant payment terminal 300 via NFC. It is necessary for the payment card information to be secured and only retrieved and communicated when the customer truly intends for it. The payment card information is initially in an inactive or non-communicable state, i.e. it cannot be communicated externally from the mobile device 200 without verification. Broadly, the method 100 seeks to verify the identity of the customer prior to communicating the payment card information to the merchant payment terminal 300 for initiation of a payment transaction, specifically a verified payment transaction, between the customer and the merchant.

Referring back to FIG. 1, the method 100 comprises a step 102 of receiving image data associated with facial features of the customer, and a step 104 of initiating a verification process 106. The verification process makes use of the image data associated with the customer's facial features to verify the identity of the customer, ensuring that he/she has the intention to make the payment transaction with the merchant.

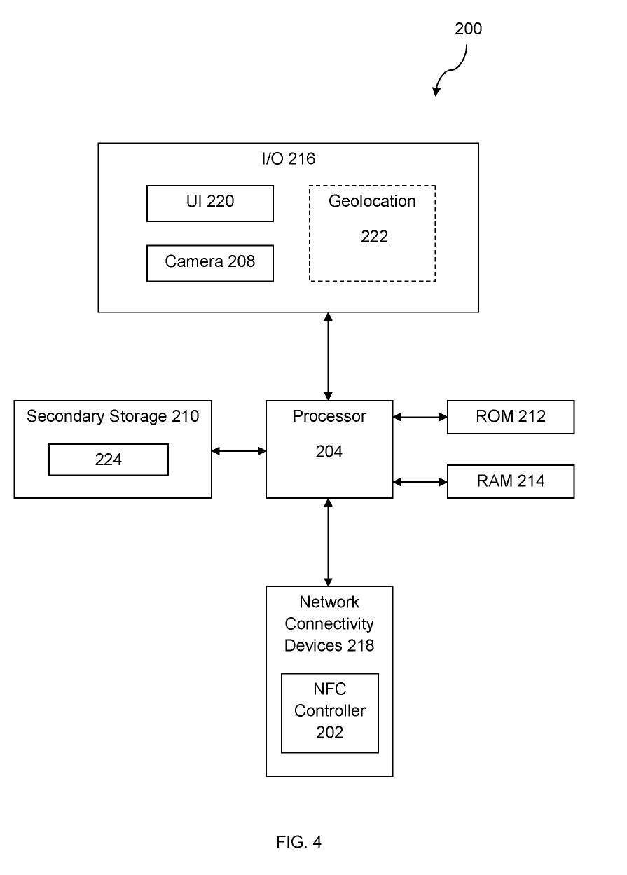

The mobile device 200 comprises an image capture device or camera 208 (with reference to FIG. 4) for the customer to capture image data. The image data may be saved on the mobile device 200 prior to further processing by the verification process 106, or may alternatively be directly processed by the verification process 106 without saving a copy of the image data on the mobile device 200. The image data comprises a set of images of the customer's face. In various embodiments, the set of images includes a still image of the customer's face. Preferably, the still image is a direct front view of the customer's face, so as to accurately capture the distinct facial features, e.g. eyes, nose, and mouth, as well as to avoid dimensional or measurement errors. Upon capture of the image data with the camera 208, the image data is used in the verification process 106 performed by the mobile device 200, specifically by the software application running on the mobile device 200. Alternatively, the image data is transmitted or communicated from the mobile device 200 to the remote server/cloud 500, where the verification process 106 may be performed.

It may be contemplated by the skilled person that the set of images may alternatively include a series of images, a video sequence, or a series of video sequences of the customer's face. For avoidance of doubt, a video sequence may also be referred to as a continuous series of still images forming the set of images. The extension of the set of images from a still image to multiple images/videos provides a higher or more stringent level of verification.

The verification process 106 comprises a step 108 of generating first facial metrics based on the image data. One way of generating the first facial metrics may be by derivation using a qualitative approach, e.g. from a visual analysis of a photo of the customer's face. More preferably, generating the first facial metrics may take a quantitative approach. For example, generating the first facial metrics may comprise calculating an aggregated value or score for the first facial metrics using algorithm(s) applied to a set of parameters associated with the facial features and structure of the customer's face according to the image data. The set of parameters may comprise numerical values for the customer's face that are calculated based on anthropometric measurements of the customer's facial features and structure using or by application of facial recognition technology on the image data. The algorithm(s) is subsequently applied using the numerical values from the set of parameters to obtain the aggregated value for the first facial metrics. Accordingly, the aggregated value is an aggregation of the values from the set of parameters using the predefined algorithm(s). The set of parameters includes at least one of but not limited to the following:

Size and shape of the eyes;

Distance between the eyes;

Size and shape of the nose;

Width of the nose;

Size and shape of the jaws;

Size and shape of the cheek bones;

Width of the mouth;

Distance between the eyes and the mouth; and

Overall width of the face or head.

Instead of calculating an aggregated value from scalar quantities derived the set of parameters, generating the first facial metrics may comprise deriving a set of feature vectors from the image data. The set of feature vectors may include various characteristics or traits of the customer's face, such as those related to colours, tones, dimensions, gradients, intensities, etc.

The verification process 106 comprises a step 110 of comparing the first facial metrics to predetermined facial metrics of the customer. The predetermined facial metrics is based on reference image data recorded from an initial registration process when the customer first begins to use the software application on the mobile device 200. In the registration process, the customer is requested to create an account, which may be linked to the customer's mobile number and/or SIM card. Alternatively, the account may be created with his/her personal login and password details. Accordingly, the customer account is associated with the reference image data that is unique to the customer. The reference image data of the customer's face is then captured with the camera 208 and the predetermined facial metrics is generated therefrom. The predetermined facial metrics may be stored on a database residing on the mobile device 200 for direct accessibility thereof, or alternatively on a database residing on the remote server/cloud 500 communicatively linked to the mobile device 200. The reference image data records a reference set of parameters according to the above list with their associated numerical values so that the first facial metrics may be reliably compared thereto in the step 110. As with generating the first facial metrics in the step 108, the predetermined facial metrics can be derived using a qualitative or quantitative approach. In the quantitative approach, an aggregated value for the predetermined facial metrics can be calculated using algorithm(s) applied to these parameters. It would be appreciated that the same algorithm(s) and the same set of parameters may be used to calculate the aggregated values for the first facial metrics and the predetermined facial metrics.

As described above, the first facial metrics and predetermined facial metrics may be generated using a set of feature vectors. The same set of feature vectors may be used to generate the facial metrics for reliable comparison in the step 110. The comparison may be by way comparing a set of measured facial features (from set of feature vectors in the first facial metrics) against a set of extracted facial features (from the set of feature vectors in the predetermined facial metrics). Further, the comparison may comprise computing distances or dimensions between corresponding feature vectors in the facial metrics.

The first facial metrics of the customer are derived or generated after the customer captures the image data with the camera 208. It may be required that the customer login details are authenticated first before capturing the image data. This also serves as a secondary security layer to ensure the customer is the person intending to initiate a verified payment transaction. The first facial metrics are then compared to the predetermined facial metrics in the step 110. The comparison assesses whether the first facial metrics matches the predetermined facial metrics, such as the aggregated value for the first facial metrics being within a predefined tolerance of the aggregated value for the predetermined facial metrics. The predefined tolerance or more broadly, the matching criterion or condition for the aggregated values may be set as a permitted range, such as 80% to 100%, or as a minimum, such as at least an 80% match. For example, if the permitted range is 80% to 100% or at least an 80% match, the alternative interpretation is that the maximum allowable error or deviation from the aggregated value for the predetermined facial metrics is 20%. Some examples of the comparison of parameters between the first facial metrics and the predetermined facial metrics are shown in Tables 1 and 2 below. For purpose of brevity, only a selected set of parameters is listed in Tables 1 and 2. It would be readily apparent that there can be more parameters for greater reliability in the comparison of the facial metrics. It would also be readily apparent that the comparison of the facial metrics may be performed based on feature vectors, in addition to or instead of the parameters.

TABLE 1

| | | |
|---|---|---|
| | Value from | Value from |
| | predetermined | first |
| Parameter | facial metrics | facial metrics |

| | | | | |
|---|---|---|---|---|
| Distance between the eyes | 60 | mm | 57 | mm |
| Width of the nose | 35 | mm | 40 | mm |
| Width of the mouth | 50 | mm | 55 | mm |
| Distance between the eyes | 100 | mm | 90 | mm |
| and the mouth | | | | |
| Overall width of the face | 150 | mm | 160 | mm |
| or head | | | | |

| | | |
|---|---|---|
| Aggregated value | 395 | 402 |
| (e.g. simple summation) | | |

TABLE 2

| | | |
|---|---|---|
| | Value from | Value from |
| | predetermined | first |
| Parameter | facial metrics | facial metrics |

| | | | | |
|---|---|---|---|---|
| Distance between the eyes | 60 | mm | 70 | mm |
| Width of the nose | 35 | mm | 36 | mm |
| Width of the mouth | 50 | mm | 55 | mm |
| Distance between the eyes | 100 | mm | 90 | mm |
| and the mouth | | | | |
| Overall width of the face | 150 | mm | 170 | mm |
| or head | | | | |

| | | |
|---|---|---|
| Aggregated value | 395 | 421 |
| (e.g. simple summation) | | |

In the examples shown in Tables 1 and 2 above, an aggregated value is calculated for each of the predetermined facial metrics and first facial metrics based on predefined algorithm(s). The algorithm(s) may stipulate that the numerical values for the parameters are simply summed together. Alternatively, a weighting may be applied to each numerical value before summing the results together. Some parameters may be allocated a greater weighting than others, e.g. a certain parameter may be more relevant than the other parameters and may be allocated a greater weighting for calculating the aggregated value. Yet alternatively, the numerical values may be multiplied together. It would be readily apparent to the skilled person that other mathematical or arithmetic functions or combination of functions may be used in the algorithm(s) to obtain the aggregated values. The number of parameters may be increased to obtain a more sensitive and accurate representation of the customer's facial features and structure as derived from the image data.

Assuming the aggregated value is a simple summation of the numerical values of the parameters, in the example shown in Table 1, the aggregated values for the predetermined facial metrics and first facial metrics would be 395 and 402, respectively. The difference between the aggregated values corresponds to a percentage deviation of 2%. If the permitted range is 90% to 100%, which translates to an allowable deviation of 10%, the first facial metrics would be a match against the predetermined facial metrics. Similarly, in the example shown in Table 2, the aggregated values for the predetermined facial metrics and first facial metrics would be 395 and 421, respectively. The difference between the aggregated values corresponds to a percentage deviation of 7%. If the permitted range is 95% to 100%, which translates to an allowable deviation of 5%, the first facial metrics would not be a match against the predetermined facial metrics.

By assessing whether the aggregated values match each other, the verification process 106 can, in a step 112, verify the customer's identity based on the comparison of the first facial metrics to the predetermined facial metrics. More particularly, the step 112 of the verification process 106 may comprise comparing a set of parameters and the resultant aggregated values between the first facial metrics and the predetermined facial metrics. Various algorithms may be employed to verify the customer's identity based on the comparison of the parameters and the resultant aggregated values. For example, a matching condition or criterion may be predefined in order to assess whether the comparison between the first facial metrics and the predetermined facial metrics can determine positive or negative verification of the customer's identity.

In various embodiments of the present disclosure, the matching condition may be predefined by the customer and/or by the banks, as described below.

In some embodiments, the matching condition may be predefined by the customer and recorded on the mobile device 200 or remote server/cloud 500. The matching condition may be predefined and adjusted by the customer as necessary, such as to be less or more stringent when determining positive verification. For example, the matching condition may be requiring the aggregated value for the first facial metrics to be within a permitted range of the aggregated value for the predetermined facial metrics, wherein the permitted range may be adjusted by the customer. The permitted range may be adjusted to be more stringent (i.e. with a smaller deviation from 100%) or less stringent (i.e. with a greater deviation from 100%).

In some situations, the customer may choose to define the matching condition to be less stringent so as to avoid or reduce the occurrence of False Non Match (FNM). FNM may occur when the customer captures a still image of his/her face to obtain the image data, but the verification process 106 fails to positively verify his/her identity. A less stringent matching condition would increase the probability of positive verifications. However, this correspondingly increases the risk of imposters, who may misuse the mobile device 200, particularly if the mobile device 200 is lost, and the payment card information becomes compromised. Instead of adjusting the matching condition, the customer may choose to re-capture and re-save the customer's reference image data as there could be errors in the initial process of registering the original reference image data.

Conversely, the customer may choose to define the matching condition to be more stringent so as to avoid or reduce the occurrence of False Match (FM). FM may occur when an imposter captures a still image of his/her face to obtain the image data, and the verification process 106 erroneously verifies him as the customer. A more stringent matching condition would reduce the probability of positive verifications from imposters. However, this correspondingly increases the probability of FNM from the true customer. The customer may try to achieve a balance by adjusting the matching condition appropriately. For example, the customer may choose to compare two facial metrics or two sets of facial metrics, i.e. first facial metrics and second facial metrics, from two different still images of his/her face, wherein each comparison may be subject to a less stringent matching condition. Although the comparison of each of the first and second facial metrics may be less stringent, the collective or combined comparison of both the first and second facial metrics would be more stringent than each on its own. It would be readily understood by the skilled person on the various possible adjustments, e.g. to the permitted range or allowable deviation, can be made on the matching condition for determining positive/negative verification of the customer's identity.

In some other embodiments, the matching condition may be defined by a separate entity instead of the customer. For example, the payment card of the customer may be issued by a financial institution, e.g. a bank. The bank may define the matching condition, e.g. a permitted range of the aggregated value for the predetermined facial metrics which the aggregated value for the first facial metrics has to fall within, approving only payment transactions if the matching condition is satisfied. Different banks have different risk profiles/policies or risk taking capabilities and may define different permitted ranges or allowable deviations from the aggregated value for the predetermined facial metrics. Banks which are highly risk averse may have a permitted range of 99% to 100% (which translates to an allowable deviation of 1%). Banks which are moderately risk averse may have a permitted range of 95% to 100% (which translates to an allowable deviation of 5%). Banks which are not so risk averse may have a permitted range of 90% to 100% (which translates to an allowable deviation of 10%). As shown in FIG. 2, The mobile device 200 and/or remote server/cloud 500 may be communicatively linked via the payment network 400 to the computing servers of the banks for data exchange of the permitted ranges and the actual matching percentages of the aggregated value for the first facial metrics against the aggregated value for the predetermined facial metrics (as determined from the comparison in step 110) to verify the customer's identity.

Thus, from the step 112 of the verification process 106, there is positive verification of the customer's identity when the comparison of the first facial metrics to the predetermined facial metrics satisfies a matching condition. For example, there is positive verification when the aggregated value for the first facial metrics falls within a permitted range of the corresponding aggregated value for the predetermined facial metrics.

More preferably, in some other embodiments, the banks may, alternative or in addition to the customer being able to, define the matching condition, e.g. the permitted range of the aggregated value for the predetermined facial metrics, to be correlated to the value of the payment transaction. More specifically, the permitted range may be more stringent if the value of the payment transaction is higher. For example, the permitted range for the aggregated value for the predetermined facial metrics may be 90% to 100% if the value is below 100 dollars, but may become more stringent at 95% to 100% if the value is between 100 and 1000 dollars. Similarly, the permitted range may narrow down to 99% to 100% for transaction values above 1000 dollars. This correlation is to provide added security to the customer by reducing the risk of unintentional high-value payment transactions. The network configuration as shown in FIG. 2 allows for data exchange of the transaction values (from the merchant), permitted ranges (from the bank), and actual matching percentages (from the mobile device 200) of the comparison of the first facial metrics to the predetermined facial metrics for verifying the customer's identity.

The method 100 further comprises a step 114 subsequent to the verification process 106. The step 114 provides authorization for details of a customer payment vehicle, e.g. payment card information as described above, to be communicated to the merchant payment terminal 300 in response to positive verification of the customer's identity from the verification process 106. In the step 114, after the customer's identity has been positively verified, the payment card information is retrieved from the database whereon it resides, and made available on the mobile device 200 to be communicated from the mobile device 200 to the merchant payment terminal 300 via NFC. Particularly, the payment card information is configured or converted from the inactive or non-communicable state to an active or communicable state, enabling the payment card information to be communicated externally to the merchant payment terminal 300. The verification of the customer's identity thus provides a security layer to ensure that the payment card information is secured and only retrieved and communicated when the customer truly intends for it.

It would be apparent to the skilled person that encryption protocols may be implemented in the communication of the payment card information from the mobile device 200 to the merchant payment terminal 300, and/or from the remote server/cloud 500 to the mobile device 200.

Further, the customer may be made known or informed of the positive verification of his/her identity and that his/her payment card information is now ready to be communicated to the merchant payment terminal 300. The software application may present a visual notification (e.g. SMS text or other forms of text messages) and/or sound/audio alert on the mobile device 200 to inform the customer in response to positive or negative verification of his/her identity. If the verification is positive, there may be a visual notification confirming this as well as displaying the payment card information on the mobile device 200, so that the customer knows which payment card is being used for the verified payment transaction. If the verification is negative, the customer can choose to re-verify by capturing another image of his/her face, or may forgo the payment transaction entirely.

If there is positive verification of the customer's identity, the payment card information will be ready to be communicated to the merchant payment terminal 300. The customer can proceed to initiate the verified payment transaction by holding the mobile device 200 over the merchant payment terminal 300, thereby communicating the payment card information thereto for subsequent processing of the payment transaction. This subsequent processing of the payment transaction is similar to a typical credit card transaction as if it was paid with a physical credit card, and would be readily understood by a person having ordinary skill in the art.

Although various embodiments of the present disclosure described herein relate to the use of a single still image of the customer's face for the image data or more specifically the set of images, it would be readily apparent to and understood by the skilled person that the image data or set of images may otherwise include a series of images, a video sequence, or a series of video sequences of the customer's face. In addition, various embodiments described herein relate to anthropometric measurements of the customer's facial features using facial recognition technology to determine the facial metrics. It is alternatively possible for the image data to include retinal information instead of anthropometric measurements. The method 100 may rely on Intelligent Retinal Imaging Systems (IRIS) together with a high-definition camera 208 of the mobile device 200 to scan or screen retinal information from the customer's eye(s).

The following is a general description of the technical architecture of the mobile device 200 and the remote server/cloud 500.

FIG. 4 illustrates a block diagram showing a technical architecture of the mobile device 200. The technical architecture includes a processor 204 (which may be referred to as a central processor unit or CPU) that is in communication with memory devices including secondary storage 210 (such as disk drives or memory cards), read only memory (ROM) 212, random access memory (RAM) 214. The processor 204 may be implemented as one or more CPU chips. The technical architecture further comprises input/output (I/O) devices 216, and network connectivity devices 218.

The I/O devices 210 comprise a user interface (UI) 220 and an image capture device or camera 208. The mobile device 200 may further include a geolocation module 222. The UI 220 may comprise a touch screen, keyboard, keypad or other known input device. The camera 208 allows a user to capture image data including a set of images (e.g. still image, series of images, video sequences), and save the captured image data in electronic form on the mobile device 200, e.g. on the secondary storage 210. The geolocation module 222 is operable to determine the geolocation of the communication device using signals from, for example global positioning system (GPS) satellites.

The secondary storage 210 is typically comprised of a memory card or other storage device and is used for non-volatile storage of data and as an over-flow data storage device if RAM 214 is not large enough to hold all working data. Secondary storage 210 may be used to store programs which are loaded into RAM 214 when such programs are selected for execution.

The secondary storage 204 has a processing component 224, comprising non-transitory instructions operative by the processor 204 to perform various operations of the method 100 according to various embodiments of the present disclosure. The ROM 212 is used to store instructions and perhaps data which are read during program execution. The secondary storage 210, the ROM 212, and/or the RAM 214 may be referred to in some contexts as computer-readable storage media and/or non-transitory computer-readable media. Non-transitory computer-readable media include all computer-readable media, with the sole exception being a transitory propagating signal per se.

The network connectivity devices 212 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. For example, the network connectivity devices 212 include the NFC controller/chip/component 202 of the mobile device 200. These network connectivity devices 212 may enable the processor 204 to communicate with the Internet or one or more intranets. With such a network connection, it is contemplated that the processor 204 might receive information from the network, or might output information to the network in the course of performing the operations or steps of the method 100. Such information, which is often represented as a sequence of instructions to be executed using processor 204, may be received from and outputted to the network, for example, in the form of a computer data signal embodied in a carrier wave.

The processor 204 executes instructions, codes, computer programs, scripts which it accesses from hard disk, floppy disk, optical disk (these various disk based systems may all be considered secondary storage 210), flash drive, ROM 212, RAM 214, or the network connectivity devices 212 (including the NFC controller 202). While only one processor 204 is shown, multiple processors may be present. Thus, while instructions may be discussed as executed by a processor 204, the instructions may be executed simultaneously, serially, or otherwise executed by one or multiple processors 204.

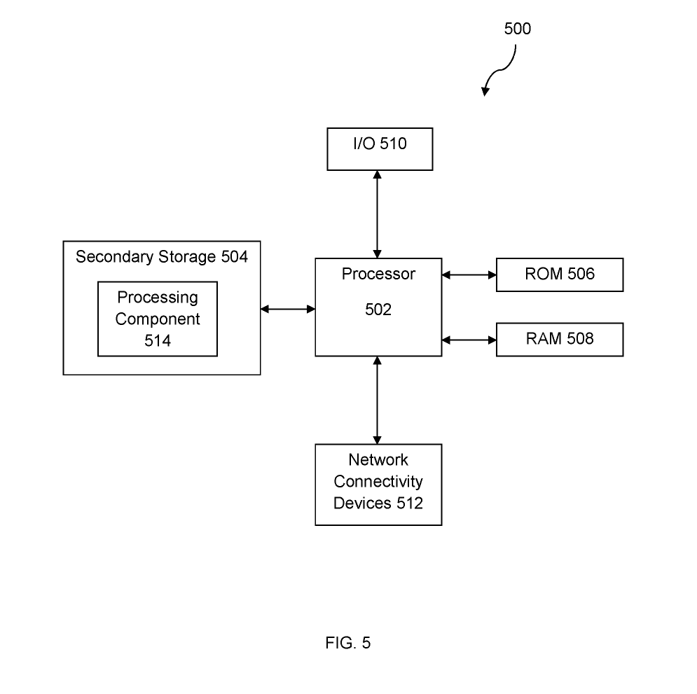

FIG. 5 illustrates a block diagram showing a technical architecture of the remote server or cloud 500. It would be readily apparent to the skilled person that the computing system of a financial institution such as an issuer server and/or acquirer server may also have this technical architecture.

The technical architecture includes a processor 502 (which may be referred to as a central processor unit or CPU) that is in communication with memory devices including secondary storage 504 (such as disk drives or memory cards), read only memory (ROM) 506, random access memory (RAM) 508. The processor 502 may be implemented as one or more CPU chips. The technical architecture further comprises input/output (I/O) devices 510, and network connectivity devices 512.

The secondary storage 504 is typically comprised of a memory card or other storage device and is used for non-volatile storage of data and as an over-flow data storage device if RAM 508 is not large enough to hold all working data. Secondary storage 504 may be used to store programs which are loaded into RAM 508 when such programs are selected for execution.

The secondary storage 504 has a processing component 514, comprising non-transitory instructions operative by the processor 502 to perform various operations of the method 100 according to various embodiments of the present disclosure. The ROM 506 is used to store instructions and perhaps data which are read during program execution. The secondary storage 504, the ROM 506, and/or the RAM 508 may be referred to in some contexts as computer-readable storage media and/or non-transitory computer-readable media. Non-transitory computer-readable media include all computer-readable media, with the sole exception being a transitory propagating signal per se.

The I/O devices 510 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 512 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 512 may enable the processor 502 to communicate with the Internet or one or more intranets. With such a network connection, it is contemplated that the processor 502 might receive information from the network, or might output information to the network in the course of performing the operations or steps of the method 100. Such information, which is often represented as a sequence of instructions to be executed using processor 502, may be received from and outputted to the network, for example, in the form of a computer data signal embodied in a carrier wave.

The processor 502 executes instructions, codes, computer programs, scripts which it accesses from hard disk, floppy disk, optical disk (these various disk based systems may all be considered secondary storage 504), flash drive, ROM 506, RAM 508, or the network connectivity devices 512. While only one processor 502 is shown, multiple processors may be present. Thus, while instructions may be discussed as executed by a processor, the instructions may be executed simultaneously, serially, or otherwise executed by one or multiple processors.

It should be appreciated that the technical architecture of the remote server/cloud 500 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the mobile device 200 or the remote server/cloud 500, at least one of the CPU 204/502, the ROM 212/506, and the RAM 214/508 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

In the foregoing detailed description, embodiments of the present disclosure in relation to a method and apparatus for initiating a verified payment transaction are described with reference to the provided figures. The description of the various embodiments herein is not intended to call out or be limited only to specific or particular representations of the present disclosure, but merely to illustrate non-limiting examples of the present disclosure. The present disclosure serves to address at least some of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A computerized method for initiating a verified payment transaction between the customer and a merchant, the method comprising:
receiving image data associated with facial features of the customer;
initiating a verification process comprising:
generating first facial metrics based on the image data;
comparing the first facial metrics to predetermined facial metrics of the customer; and
verifying the customer's identity based on the comparison of the first facial metrics to the predetermined facial metrics; and
providing authorization for details of a customer payment vehicle to be communicated to a merchant payment terminal in response to positive verification of the customer's identity from the verification process,
wherein the payment transaction is initiated upon communication of the details of the customer payment vehicle to the merchant payment terminal.

2. The method according to claim 1, further comprising communicating the customer payment vehicle details to the merchant payment terminal for subsequent processing of the payment transaction.

3. The method according to claim 1, wherein the image data comprises a set of images captured with a customer mobile device.

4. The method according to claim 3, wherein the customer mobile device is communicable with the merchant payment terminal via a wireless communication protocol.

5. The method according to claim 4, wherein the wireless communication protocol comprises radio-frequency identification (RFID) and/or near-field communication (NFC).

6. The method according to claim 3, wherein the set of images comprises a continuous series of images forming a video sequence.

7. The method according to claim 1, wherein the verification process is performed by the customer mobile device.

8. The method according to claim 1, wherein the verification process is performed by a remote server communicatively linked to the customer mobile device.

9. The method according to claim 8, further comprising communicating the image data to the remote server.

10. The method according to claim 8, wherein the predetermined facial metrics are stored on a database residing on the remote server.

11. The method according to claim 1, wherein the verification process further comprises calculating the first facial metrics based on a set of parameters derived from the image data.

12. The method according to claim 11, wherein there is positive verification of the customer's identity when the comparison of the first facial metrics to the predetermined facial metrics satisfies a matching condition.

13. The method according to claim 12, wherein the matching condition is correlated to the value of the payment transaction.

14. The method according to claim 1, further comprising authenticating customer login details before receiving the image data.

15. The method according to claim 1, further comprising informing the customer in response to positive or negative verification of the customer's identity.

16. The method according to claim 1, wherein generating the first facial metrics comprises measuring dimensions of the facial features based on the image data.

17. The method according to claim 1, wherein the image data comprises retinal information.

18. A non-transitory computer-readable medium storing computer-readable instructions that, when executed, cause a processor to perform steps of a method for initiating a verified payment transaction between the customer and a merchant, the method comprising:
receiving image data associated with facial features of the customer;
initiating a verification process comprising:
generating first facial metrics based on the image data;
comparing the first facial metrics to predetermined facial metrics of the customer; and
verifying the customer's identity based on the comparison of the first facial metrics to the predetermined facial metrics; and
providing authorization for details of a customer payment vehicle to be communicated to a merchant payment terminal in response to positive verification of the customer's identity from the verification process,
wherein the payment transaction is initiated upon communication of the details of the customer payment vehicle to the merchant payment terminal.

19. The non-transitory computer-readable medium according to claim 18, wherein the computer-readable instructions that when executed, further cause the processor to communicate the customer payment vehicle details to the merchant payment terminal for allowing the merchant to receive funds for the payment transaction.

20. The non-transitory computer-readable medium according to claim 18, wherein the computer-readable instructions that when executed, further cause the processor to calculate the first facial metrics based on a set of parameters derived from the image data.

21. The non-transitory computer-readable medium according to claim 18, wherein the computer-readable instructions that when executed, further cause the processor to authenticate customer login details before receiving the image data.

22. The non-transitory computer-readable medium according to claim 18, wherein the computer-readable instructions that when executed, further cause the processor to inform the customer in response to positive or negative verification of the customer's identity.

23. An apparatus for initiating a verified payment transaction between the customer and a merchant, the apparatus comprising:
a processor; and
a non-transitory memory configured to store computer-readable instructions that, when executed, cause the processor to perform steps of a method comprising:
receiving image data associated with facial features of the customer;
initiating a verification process comprising:
generating first facial metrics based on the image data;
comparing the first facial metrics to predetermined facial metrics of the customer; and
verifying the customer's identity based on the comparison of the first facial metrics to the predetermined facial metrics; and
providing authorization for details of a customer payment vehicle to be communicated to a merchant payment terminal in response to positive verification of the customer's identity from the verification process,
wherein the payment transaction is initiated upon communication of the details of the customer payment vehicle to the merchant payment terminal.
